(19) United States
(12) Patent Application Publication
(10) Pub. No.: US 2016/0347505 A1
(43) Pub. Date: Dec. 1, 2016

(54) MISCELLANEOUS WATERPROOF BUCKET RING

(71) Applicant: RICHARD AUSTIN MCLENDON, JACKSONVILLE, FL (US)

(72) Inventor: RICHARD AUSTIN MCLENDON, JACKSONVILLE, FL (US)

(21) Appl. No.: 14/726,775

(22) Filed: Jun. 1, 2015

(51) Int. Cl. B65D 25/10; F42B 39/26; B65D 25/32; B25H 3/00

(52) U.S. Cl. CPC B65D 25/108; B25H 3/00; F42B 39/26; B65D 25/32; B65D 2525/285

(57) ABSTRACT

The apparatus disclosed is providing a receptacle container attachment for a tool such as but not limited to wrenches; inserted type; socket type; drills and taps also electrical cords, drill motors, saws and ammunition that offers both organization and waterproof protection. MISCELLANEOUS WATERPROOF BUCKET RING is particularly adapted to be a waterproof toolbox and a visually indicated tool organizer that is convenient and easy to use, and designed for easily and conveniently organizing and protecting such as but not limited to an artisan's tools while working or ammunition while hunting, specifically in wet weather.

### CROSS REFERENCE TO RELATED APPLICATIONS

This application claims the benefit of U.S. Provisional Application No. 62/022,438 filed 09 Jul. 2014, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

Field of the Invention

This invention relates generally to the U.S. Patent classification definitions, technical field of but not limited to Class 220 RECEPTACLES subclass 694, CONTAINER ATTACHMENT OR ADJUNCT; and Class 206 SPECIAL RECEPTACLE OR PACKAGE subclass 349 FOR A TOOL; and subclass 376 WRENCHES; and subclass 377 INSERTED TYPE; and subclass 378 SOCKET TYPE; and subclass 379 DRILLS AND TAPS also Class 220 Receptacles/752; also Class 224/235 Package and article carrier. Said MISCELLANEOUS WATERPROOF BUCKET RING is particularly adapted to use by a plurality of artisans who use tools or implements by hand and wish to be able to protect said tools from water damage.

Prior Art

Many individuals utilize buckets or sacks to transport a plurality of things such as but not limited to tools. This practice is useful while working in different locations or in areas having a height wherein having to climb up and down a ladder is inconvenient.

For example, U.S. Pat. No. 2009/250,470; dated 2009, discloses a TOOL BUCKET. Similarly, other devices known in the art that relate to tool insert devices for buckets exist. Some devices in said prior art disclose a tool holder having a plurality of apertures for holding tools wherein said device can be placed inside of a bucket. Other devices in said prior art describe a tool holder insert for a bucket that can store and organize hand tools therein. Said devices, however configured, maybe suitable for keep tools together and from falling out of said tool bucket; however, none disclose a waterproof tool holder having a lid that can be placed over a bucket.

Accordingly, a need remains for a MISCELLANEOUS WATERPROOF BUCKET RING in order to overcome the above-noted shortcomings. The non-limiting exemplary embodiments satisfies such a need by providing a receptacle container attachment for a tool such as but not limited to wrenches, inserted type, socket type, drills and taps also electrical cords, drill motors, saws and ammunition that offers both organization and waterproof protection. Said MISCELLANEOUS WATERPROOF BUCKET RING is particularly adapted to be both a tool box and a visually indicated tool organizer that is convenient and easy to use, lightweight yet durable in design, versatile in its applications, and designed for easily and conveniently organizing and protecting an artisan's tools or a hunters ammunition while working or hunting, specifically in wet weather.

### BRIEF SUMMARY OF THE INVENTION

In view of the foregoing background, it is therefore an object of the non-limiting exemplary embodiments to provide a brief summary on MISCELLANEOUS WATERPROOF BUCKET RING, some of the advantages are: provides a combination bucket and a tool holder insert device. Said device comprises a bucket having a removably attached annular tool holder configured to fit inside of said bucket so that MISCELLANEOUS WATERPROOF BUCKET RING remains suspended proximate the middle of said bucket without falling to the bottom. MISCELLANEOUS WATERPROOF BUCKET RING comprises a plurality of geometric shapes, apertures or slots that are radially separated at predetermined random or regular intervals, and suitable to organize an artisan's tools. MISCELLANEOUS WATERPROOF BUCKET RING further comprises a removable lid which covers the open end of said bucket and protect said artisan's tools from water.

Embodiments described below demonstrate how said MISCELLANEOUS WATERPROOF BUCKET RING solves many of the prior art problems.

Described in one embodiment is said bucket; and

in another embodiment said annular tool holder's plurality of geometric shapes, apertures or slots is described; and

an additional embodiment of said invention describes how said annular tool holder is configured to fit inside said bucket; and

a removable interior cap of said MISCELLANEOUS WATERPROOF BUCKET RING is described in another embodiment of the invention; and

another embodiment describes said removable lid.

These and other objects, features, and advantages of the invention are provided by description of the preferred embodiments.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and

Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective cut away view showing MISCELLANEOUS WATERPROOF BUCKET RING, in accordance with the non-limiting exemplary embodiments;

FIG. 2 is perspective view showing the MISCELLANEOUS WATERPROOF BUCKET RING;

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The non-limiting exemplary embodiments will now be described more fully hereinafter with reference to the accompanying drawings, in which a preferred embodiment of the invention is shown. This invention may, however, be embodied in many different forms and should not be construed as limited to the embodiment set forth herein. Rather, these embodiments are provided so that this application will be thorough and complete, and will fully convey the true scope of the invention to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “non-limiting exemplary embodiments” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the non-limiting exemplary embodiments. Thus, to the maximum extent allowed by law, the scope of the non-limiting exemplary embodiments is to be determined by the broadest permissible interpretation of the following claims and their equivalents, and shall not be restricted or limited by the foregoing detailed description.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “non-limiting exemplary embodiment” in various places in the specification are not necessarily all meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

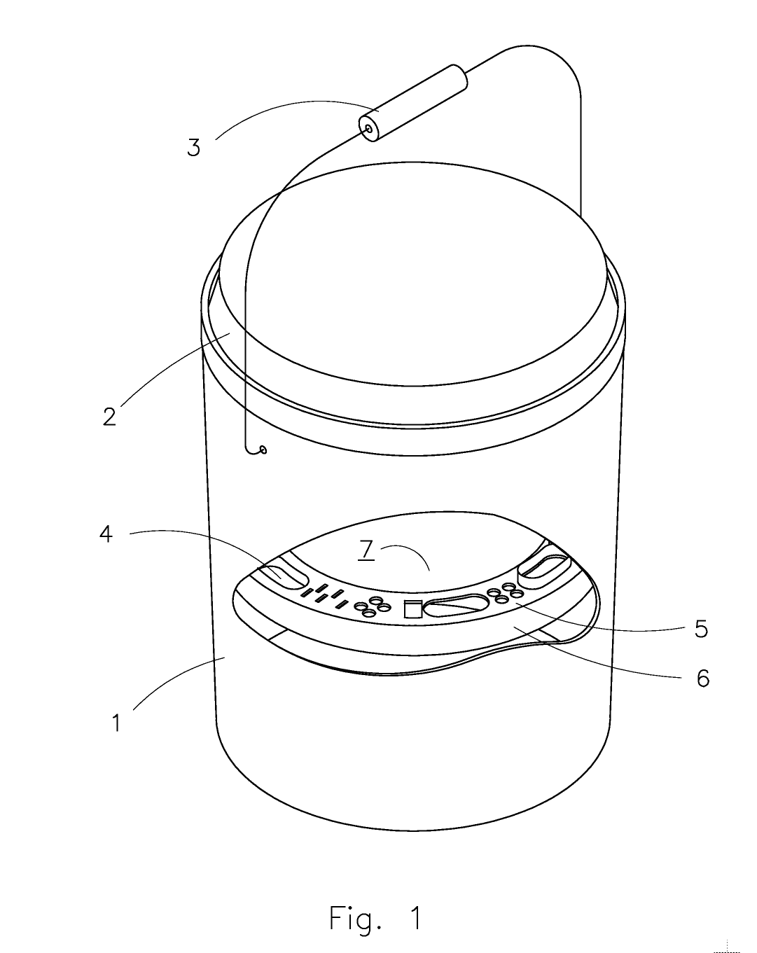

The apparatus of this invention referred to generally in FIG. 1 intends to provide a perspective cut away view showing MISCELLANEOUS WATERPROOF BUCKET RING. It should be understood that the non-limiting exemplary embodiments may be used to describe similar apparatus and many different types of devices that could used to organize and protect tools and should not be limited to the uses described herein. The descriptor nomenclature legend that follows is not meant to be all encompassing but to aid the reader in understanding the figures within the drawings.

### Bucket 1; and

### Lid 2; and

### Handle 3; and

Plurality of geometric shapes, apertures or slots 4; and
Annular ring 5; and
Tapered side 6; and
Removable interior cap 7.

Viewing FIG. 1, a perspective cut away view, MISCELLANEOUS WATERPROOF BUCKET RING shown with descriptors number 1, 2, 3, 4, 5, 6 and 7 illustrating some embodiment of the invention. Viewing said bucket 1 having at least a lid 2 and at least one handle 3 and an annular ring 5; said annular ring 5 having a removable inner cap. Said MISCELLANEOUS WATERPROOF BUCKET RING constructed of a material that withstands cold, frost, rain and the stress applied when carrying heavy tools. The bucket 1 inner body is generally cylindrical in shape, having a gradual taper, hollow and ridged. Proximate top end said bucket 1 is open and oppositely bottom end is closed. Furthermore proximate said top end exist a handle 3 suitable for carrying bucket 1. Said handle 3 attaches by a means to exterior of said bucket 1. Said handle 3 is movable and removable from bucket 1.

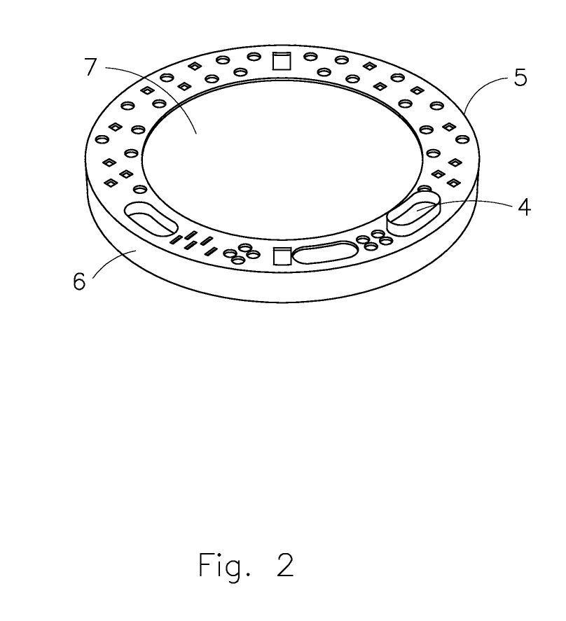

Viewing FIG. 2, showing descriptors 4, 5, 6, & 7 the reader can see said annular ring 5 comprises a plurality of geometric shapes, apertures or slots that are adapted to organize and to hold hand tools or ammunition therein.

Yet in another embodiment and still viewing FIG. 1, said annular ring 5 held in place by force proximate middle of said bucket 1. In addition, said annular ring 5 having an exterior and an interior. Said exterior having a circumference which is tapered to meet and wedge proximate middle interior said bucket 1. Said removable interior cap 7 fits into and covers said interior of annular ring 5 which is a hollow area so as to allow an artisan to place items beneath said annular ring 5.

A further embodiment also viewed on FIG. 1, and that is lid 2 is adapted to cover said open end of bucket 1 and may be padded exterior.

Such a configuration provides the expected and predictable advantage of a convenient means to transport, organize and store multiple tools in a bucket when working while also providing protection to said tools from water.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the non-limiting exemplary embodiments may include variations in size, materials, shape, form, function and manner of operation.

What is claimed as new and what is desired to secure by Letters Patent of the United States is:

1. A MISCELLANEOUS WATERPROOF BUCKET RING comprising:
a tapered cylinder having an open top end, and a closed bottom end;
a handle removably mounted proximate open top end;
an exteriorly padded lid removably mounted proximate open top end;
an annular ring capable of being forcibly mounted interior;
a plurality of geometrical shapes passing through annular ring capable of holding tools;
a plurality of geometrical shapes capable of supporting and holding ammunition;
a lid that can be placed over said bucket.
